(19) United States
(12) Patent Application Publication
(10) Pub. No.: US 2026/0155719 A1
(43) Pub. Date: Jun. 4, 2026

(54) ELECTROMAGNETIC PUMP AND METHOD FOR MANUFACTURING THE SAME

(71) Applicant: Nano Nuclear Energy Inc., New York, NY (US)

(72) Inventor: Carlos Omar Maidana, Pocatello, ID (US)

(21) Appl. No.: 19/030,098

(22) Filed: Jan. 17, 2025

Related U.S. Application Data
(60) Provisional application No. 63/727,833, filed on Dec. 4, 2024.

(51) Int. Cl. H02K 15/40; B33Y 10/00; H02K 15/043; H02K 44/02

(52) U.S. Cl. CPC H02K 15/40; H02K 15/043; B33Y 10/00; H02K 44/02

(57) ABSTRACT

An electromagnetic pump and method of manufacturing is provided. In some aspects, the method includes producing a hollow duct, producing a core, producing a coil assembly comprising a first set of coil units, a second set of coil units, and a third set of coil units, and producing a stator assembly comprising a plurality of stator units. The method also includes assembling the electromagnetic pump by arranging the first set of coil units, the second set of coil units, and the third set of coil units about the hollow duct, arranging the plurality of stator units about the hollow duct to receive a portion of the first set of coil units, the second set of coil units, and the third set of coil units; and arranging the core inside the hollow duct to form an annular channel between the hollow duct and core for carrying a conductive fluid.

### CROSS-REFERENCE TO RELATED APPLICATIONS

The present application is based on and claims the benefit of U.S. Provisional Application No. 63/727,833, filed on Dec. 4, 2024 and titled “ELECTROMAGNETIC PUMP AND METHOD FOR MANUFACTURING THE SAME,” which is incorporated herein by reference in its entirety.

### STATEMENT REGARDING FEDERALLY SPONSORED RESEARCH AND DEVELOPMENT

This invention was made with government support under SBIR Grant Nos. DE-SC0019835, DE-SC0022805, and DE-SC0013992 awarded by U.S. Department of Energy. The government has certain rights in the invention.

### TECHNICAL FIELD

This disclosure relates generally to cooling and fluid control technologies, and more particularly, to an electromagnetic pump for moving a conducting fluid and method for manufacturing the same.

### BACKGROUND

A Molten Salt Reactor (MSR) is a type of nuclear reactor that produces heat, which can be used in electricity generation, high-temperature process heat, and other applications. Unlike traditional nuclear reactor technologies, an MSR utilizes a molten salt mixture as both coolant and fuel, with most of its volume residing in the reactor core. Molten salt can provide efficient heat removal from a reactor's core, reducing piping requirements, and decreasing overall core dimensions due to reduced component size. While operating at high temperatures and low pressures, an MSR can be efficient at generating energy, and can enhance safety by reducing risk of large breaks and loss of coolant. In addition, an MSR can generate less waste because it does not require solid fuel and infrastructure for disposing spent fuel. Furthermore, an MSR can adapt to a variety of nuclear fuel cycles (such as Uranium-Plutonium and Thorium-Uranium cycles), which can extend fuel resources. For instance, an MSR can be designed as nuclear waste “burners” or breeders.

A liquid metal-cooled reactor, such as a fast neutron reactor, is another type of nuclear reactor that is both moderated and cooled by a liquid metal solution. With a compact footprint, a liquid metal-cooled reactor can be used for electric power generation in isolated places, for fission surface power units for planetary exploration, for naval propulsion, and as part of space nuclear propulsion systems. A liquid metal-cooled reactor may be desirable for space, as well as other applications in which transportability, weight, reliability, efficiency, working environment, and so forth, are a factor.

While water could be theoretically used for reactor cooling, in practice, water has a low boiling point, and tends to slow down and absorb neutrons. This limits the amount of water that can flow through a reactor core, and any water-based cooling system would need to be operated at high pressure to provide effective cooling. Therefore, liquid metal or molten metal is typically utilized for heat removal and transport.

While molten salt and liquid-metal can provide some benefits to reactor cooling, they present technical challenges. For instance, traditional pumps for circulating liquid metal include mechanical radial or axial pump designs. However, liquid metal can be very corrosive to these traditional pumps, and cause significant damage to pump impeller, bearings, seals, and so forth. Also, traditional pumps can suffer from significant cavitation, which can cause unwanted damage, vibration, energy consumption, and reduced lifespan. Similarly, molten salt can also be highly corrosive, and corrosivity increases with temperature.

Therefore, there is a need for improved cooling and fluid control technologies.

### SUMMARY

According to some implementations of the present disclosure, a method for manufacturing an electromagnetic pump is provided. In some aspects, the method includes producing a hollow duct that extends from a first duct end to a second duct end, the hollow duct having an inlet portion, a central portion, and an outlet portion, producing a core that extends from the first core end to a second core end, producing a coil assembly comprising a first set of coil units, a second set of coil units, and a third set of coil units, wherein the first set of coil units, the second set of coil units, and the third set of coil units are operable to generate a time-varying magnetic field, and producing a stator assembly comprising a plurality of stator units. The method also includes assembling the electromagnetic pump by arranging the first set of coil units about an inlet portion of the hollow duct, the second set of coil units about a central portion of the hollow duct, and the third set of coil units about an outlet portion of the hollow duct, arranging the plurality of stator units about the hollow duct to receive a portion of the first set of coil units, the second set of coil units, and the third set of coil units, and arranging the core inside the hollow duct to form an annular channel between the hollow duct and core for carrying a conductive fluid in response to the time-varying magnetic field.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present approach, when taken in connection with the accompanying drawings and the appended claims.

### BRIEF DESCRIPTION OF THE DRAWINGS

The foregoing and other advantages of the present disclosure will become apparent upon reading the following detailed description and upon reference to the drawings.

FIG. 1A is perspective illustration of an electromagnetic pump, according to aspects of the present disclosure;

FIG. 1B is another perspective illustration of the electromagnetic pump in FIG. 1A, according to aspects of the present disclosure;

FIG. 1C is a front view of the electromagnetic pump in FIG. 1A, according to aspects of the present disclosure;

FIG. 1D is a cross-sectional view of the electromagnetic pump in FIG. 1A, according to aspects of the present disclosure;

FIG. 2A is a perspective illustration of an example hollow duct for the electromagnetic pump in FIG. 1A, according to aspects of the present disclosure;

FIG. 2B is another perspective illustration of the hollow duct in FIG. 2A, according to aspects of the present disclosure;

FIG. 3A is a perspective illustration of an example core for the electromagnetic pump in FIG. 1A, according to aspects of the present disclosure;

FIG. 3B is a cross-section of the core in FIG. 3A, according to aspects of the present disclosure;

FIG. 3C is a cross-section of a portion of the core in FIG. 3A, according to aspects of the present disclosure;

FIG. 3D is another cross-section of the core in FIG. 3A, according to aspects of the present disclosure;

FIG. 3E is a side view of the core in FIG. 3A, according to aspects of the present disclosure;

FIG. 3F is another side view of the core in FIG. 3A, according to aspects of the present disclosure;

FIG. 4A is a perspective view of an example coil assembly for the electromagnetic pump in FIG. 1A, according to aspects of the present disclosure;

FIG. 4B is a perspective view of an example coil unit for the coil assembly of FIG. 4A, according to aspects of the present disclosure;

FIG. 4C is a perspective view of the coil unit in FIG. 4A, according to aspects of the present disclosure;

FIG. 4D is an illustration of another example coil unit with a conductive matrix, according to aspects of the present disclosure;

FIG. 5A is a perspective view of an example stator unit for the electromagnetic pump in FIG. 1A, according to aspects of the present disclosure;

FIG. 5B is a cross-section of the stator unit of FIG. 5A, according to aspects of the present disclosure;

FIG. 5C is a side view of the stator unit in FIG. 5A, according to aspects of the present disclosure;

FIG. 6A is a perspective view of an example cooling stack for the electromagnetic pump in FIG. 1A, according to aspects of the present disclosure;

FIG. 6B is an illustration of a cooling unit in the cooling stack of FIG. 6A, according to aspects of the present disclosure;

FIG. 6C is a side view of the cooling unit in FIG. 6B, according to aspects of the present disclosure;

FIG. 6D is another side view of the cooling unit in FIG. 6B, according to aspects of the present disclosure;

FIG. 7A is a perspective illustration of an example cooling sleeve for the electromagnetic pump in FIG. 1A, according to aspects of the present disclosure;

FIG. 7B is another perspective illustration of the cooling sleeve of FIG. 7B, according to aspects of the present disclosure;

FIG. 8A is a perspective illustration of components of a support structure for the electromagnetic pump of FIG. 1A, according to aspects of the present disclosure;

FIG. 8B is another perspective illustration of components of a support structure for the electromagnetic pump of FIG. 1A, according to aspects of the present disclosure;

FIG. 9 is a flowchart setting forth steps of a process of manufacturing an electromagnetic pump, according to aspects of the present disclosure;

FIG. 10A is a perspective illustration showing a step in the process of manufacturing of FIG. 9, according to aspects of the present disclosure;

FIG. 10B is a perspective illustration showing another step in the process of manufacturing of FIG. 9, according to aspects of the present disclosure;

FIG. 10C is a perspective illustration showing yet another step in the process of manufacturing of FIG. 9, according to aspects of the present disclosure;

FIG. 10D is a perspective illustration showing yet another step in the process of manufacturing of FIG. 9, according to aspects of the present disclosure;

FIG. 10E is a perspective illustration showing yet another step in the process of manufacturing of FIG. 9, according to aspects of the present disclosure;

FIG. 10F is a perspective illustration showing yet another step in the process of manufacturing of FIG. 9, according to aspects of the present disclosure;

FIG. 10G is a perspective illustration showing yet another step in the process of manufacturing of FIG. 9, according to aspects of the present disclosure;

FIG. 10H is a perspective illustration showing yet another step in the process of manufacturing of FIG. 9, according to aspects of the present disclosure;

FIG. 10I is a perspective illustration showing yet another step in the process of manufacturing of FIG. 9, according to aspects of the present disclosure;

FIG. 10J is a perspective illustration showing yet another step in the process of manufacturing of FIG. 9, according to aspects of the present disclosure;

FIG. 10K is a perspective illustration showing yet another step in the process of manufacturing of FIG. 9, according to aspects of the present disclosure.

While the present disclosure is susceptible to various modifications and alternative forms, specific implementations have been shown by way of example in the drawings and will be described in further detail herein. It should be understood, however, that the present disclosure is not intended to be limited to the particular forms disclosed. Rather, the present disclosure covers modifications, equivalents, and alternatives falling within the spirit and scope of the present disclosure as defined by the appended claims.

### DETAILED DESCRIPTION

Molten salt and liquid-metal commonly used for reactor cooling can present various technical challenges to conventional pump technologies, including undesirable damage, cavitation, vibration, higher energy consumption, reduced lifespan, and so forth. Also, intense radiation, high operational temperatures, and corrosion associated with molten salt and liquid-metal present difficult conditions for conventional pump technologies.

The present disclosure describes various embodiments of an electromagnetic pump, and methods for manufacturing the same. As appreciated from description herein, the present disclosure introduces an approach that provides a number of advantages over conventional technologies, including predictability, reliability, economies of scale, and so forth.

The present disclosure is described with reference to the attached figures, where like reference numerals are used throughout the figures to designate similar or equivalent elements. The figures are not drawn to scale, and are provided merely to illustrate the instant disclosure. Several aspects of the disclosure are described below with reference to example applications for illustration. It should be understood that numerous specific details, relationships, and methods are set forth to provide a full understanding of the disclosure. One having ordinary skill in the relevant art, however, will readily recognize that the disclosure can be practiced without one or more of the specific details, or with other methods. In some instances, certain structures or operations are not shown in detail to avoid obscuring the disclosure. The present disclosure is not limited by illustrated ordering of steps, acts or events, as some steps, acts, or events may occur in different orders and/or concurrently with other steps, acts, or events. Furthermore, not all illustrated steps, acts, or events are required to implement an approach described in the present disclosure.

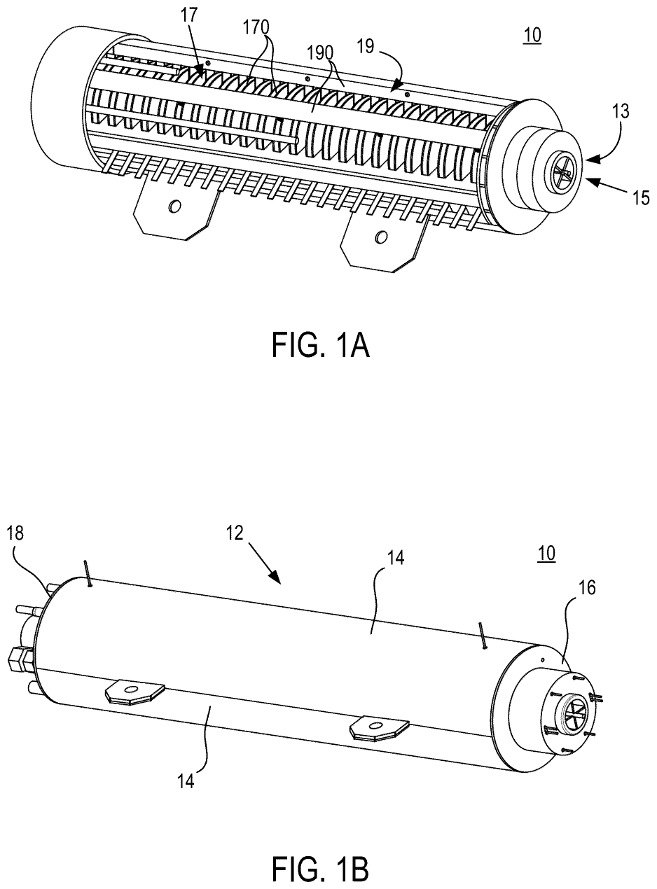

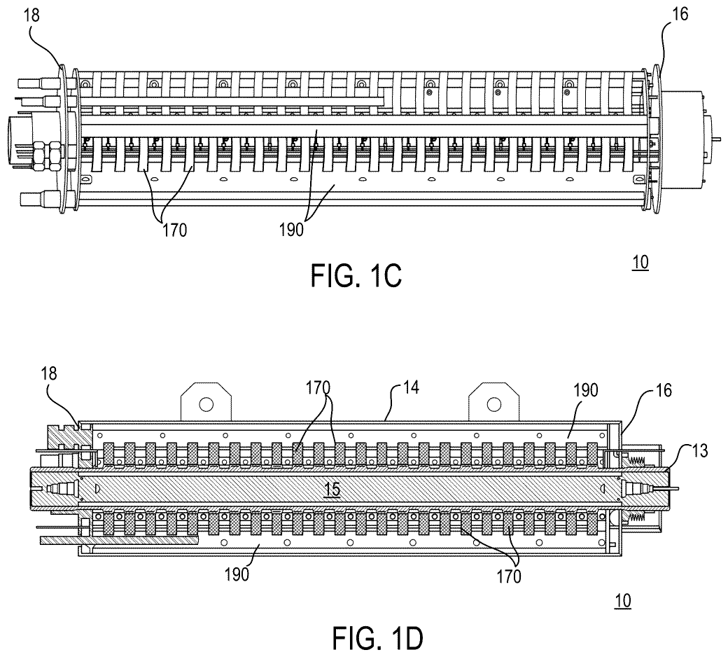

Turning now to FIGS. 1A to 1D, an electromagnetic pump 10 for moving a conductive fluid, in accordance with aspects of the present disclosure, is illustrated. Referring specifically to FIG. 1A, the electromagnetic pump 10 may generally include a hollow duct 13, core 15, a coil assembly 17 that includes a number of coil units 170, and a stator assembly 19 that includes a number of stator units 190. In some embodiments, as shown in FIG. 1B, the electromagnetic pump 10 may include a support structure 12 to secure and protect various components of the electromagnetic pump. For instance, in some embodiments, the support structure 12 may include an enclosure 14 (e.g., formed by one or more shell), a first end plate 16, a second end plate 18, which when assembled, at least partially encase the hollow duct 13, the core 15, the coil assembly 17, and the stator assembly 19, as illustrated in FIG. 1B.

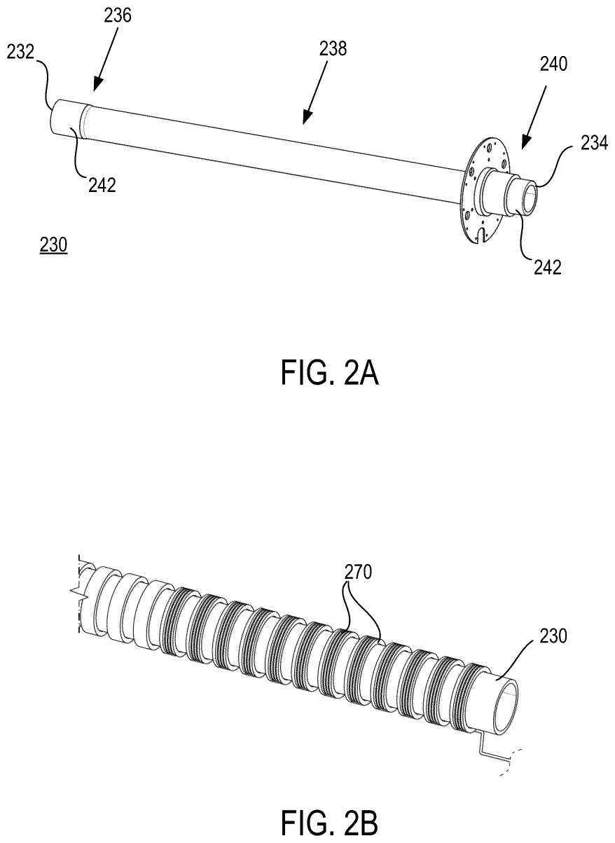

Referring particularly to FIGS. 2A and 2B, one embodiment of a hollow duct 230, in accordance with aspects of the present disclosure, is illustrated. As shown, the hollow duct 230 extends from a first duct end 232 to a second duct end 234, and may include an inlet portion 236, a central portion 238, and an outlet portion 240. In some embodiments, the inlet portion 236, the outlet portion 240, or both, may include an enlarged section 242 with an outer diameter that is larger than the outer diameter of the hollow duct 230 at the central portion 238. The enlarged section 242 may help facilitate installation and/or securing of one or more component thereto, such as a structure plate, as illustrated in FIG. 2A. In some embodiments, the hollow duct 230 may have a number of coil units 270 arranged thereon, as illustrated in FIG. 2B.

A shape, dimension, and/or material used to form the hollow duct 230 may vary. In some applications, material used to form the hollow duct 230 may be compatible with high temperature operation and/or corrosive environment. For example, the hollow duct 230 may be produced using a high-temperature alloy material, such as a Ni—Cr alloy material (e.g., Hastelloy, Iconel 617, and so forth). In some embodiments, the hollow duct 230 may include a protective layer that lines the hollow duct 230. Such protective layer may have a thickness of at least 50 micrometers, or more. By way of example, a protective layer may include as a Ni layer, an alumina layer, and so forth.

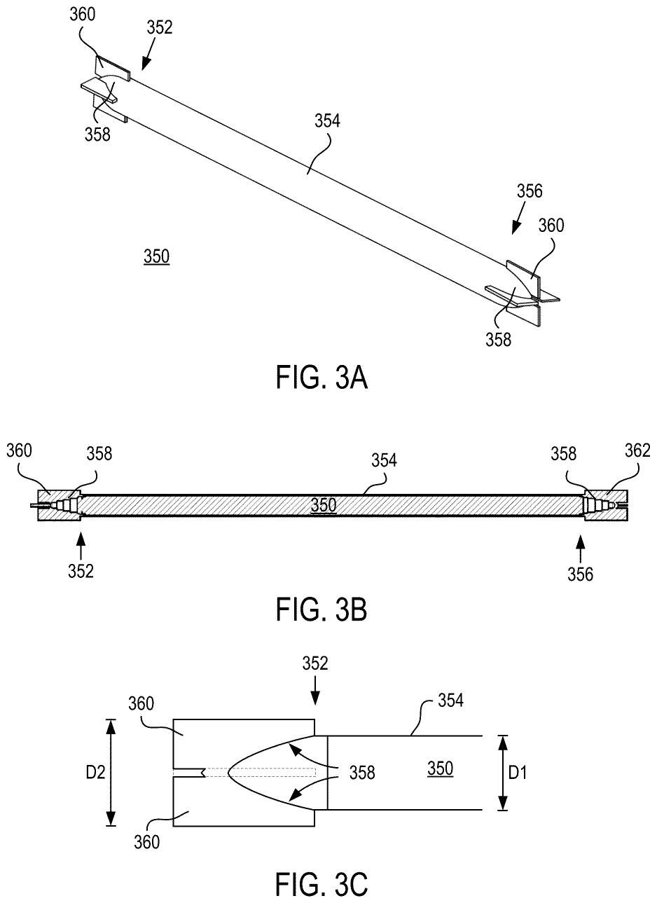

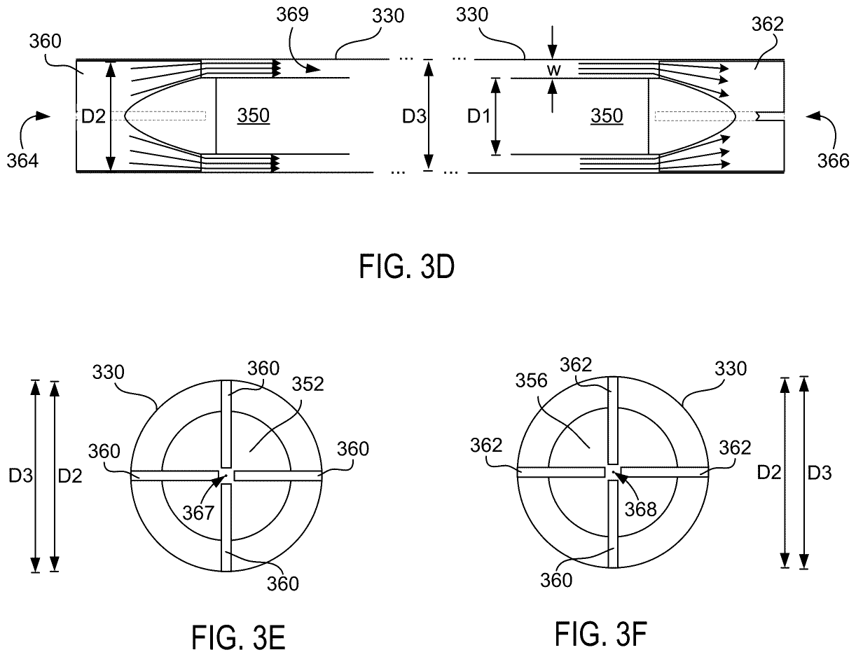

Referring particularly to FIGS. 3A-3F, one embodiment of a core 350, in accordance with aspects of the present disclosure, is illustrated. Referring particular to FIGS. 3A and 3B, the core 350 may include a first core end 352, a core body 354, and a second core end 356. The first core end 352, the second core end 356, or both may be integrated with or connected to the core body 354 in any number of ways, such as using fasteners, interference fitting, forming, welding, and so forth. In some embodiments, an outer diameter D1 of the first core end 352 and the second core end 356 of the core 350 may include a taper 358, as illustrated in FIG. 3C. In some embodiments, the taper 358 may be configured to prevent or minimize turbulent flow movement of conducting fluid. As illustrated in FIG. 3A, the core 350 may be in the form of a torpedo core.

In some embodiments, the core 350 may include a first set of fins 360 at the first core end 352 and a second set of fins 362 at the second core end 356. The first set of fins 360, may be attached to, or may extend from, the first core end 352, and the second set of fins 362, may be attached to, or may extend from, the second core end 356. As shown in FIG. 3C, the first set of fins 360, and the second set of fins 362, may extend radially outward to an outer diameter D2. While FIGS. 3A-3F show each set of fins to include 4 fins, fewer or more fins may be possible.

In some embodiments, an interior of the core 350 includes a solid rod. In other embodiments, the interior of the core 350 includes a tube. In yet other embodiments, the interior of the core 350 includes a radially laminated rod or a radially laminated tube. The interior of the core 350 may include a magnetic material, although other materials. For instance, in some embodiments, the interior of the core 350 may include a magnetic rod or magnetic tube made from magnetic material. In one non-limiting example, the magnetic material may include a Fe—Co—V alloy material. In particular, utilizing a magnetic material in the interior of the core 350 may help direct or control a component of magnetic field (e.g., a radial component) generated by a coil assembly, as described herein. For instance, by way of structure and/or magnetization of magnetic material in the interior of the core 350, magnetic field generated by one or more coil units in the coil assembly by may be directed radially at one or more point on the outer diameter of the core 350, so as help close a magnetic circuit for the magnetic field.

In some implementations, the core 350 may be positioned inside a hollow duct 330, as illustrated in FIGS. 3D to 3F. When positioned inside the hollow duct 330, the first set of fins 360 and the second set of fins 362 of the core 350 may be used align the core 350 inside the hollow duct 330. To this end, each fin of the first set of fins 360 and the second set of fins 362 may extend radially to an outer diameter D2 that is close to an inner diameter D3 of the hollow duct 330, as shown in FIG. 3D. For instance, in some embodiments, a difference between the outer diameter D2 and the inner diameter D3 of the hollow duct 330 may be within a clearance sufficient for inserting the core 350 inside the hollow duct 330, as well as maintaining a tight or interference fit between the hollow duct 330 and the core 350. For example, a difference between the outer diameter D2 and inner diameter D3 may be approximately 0.01″, or less.

When assembled, the hollow duct 330 and core 350 form a channel that may carry a conducting fluid therethrough. For instance, in some applications, the conducting fluid may include a fluid at a high temperature, such as a molten salt, a liquid metal, and so forth. The channel produced by the hollow duct 330 and core 350 may extend from an inlet 364 at the first core end 352 of the core 350 to an outlet 366 at the second core end 356 of the core 350, as illustrated in FIG. 3D. In some embodiments, the inlet 364 may include an inlet nozzle 367 produced by the first set of fins 360, as seen in FIG. 3E. Similarly, the outlet 366 may include an outlet nozzle 368 produced by the second set of fins 362, as seen in FIG. 3F. As appreciated from FIGS. 3E and 3F, the inlet 364 may include other openings produced by the first set of fins 360, and the outlet 366 may include other openings produced by the second set of fins 362. In some embodiments, at least a portion of the channel is an annular channel 369 with a width w defined by a difference between the outer diameter D1 of the core 350 and the inner diameter D3 of the hollow duct 330, as shown in FIG. 3D.

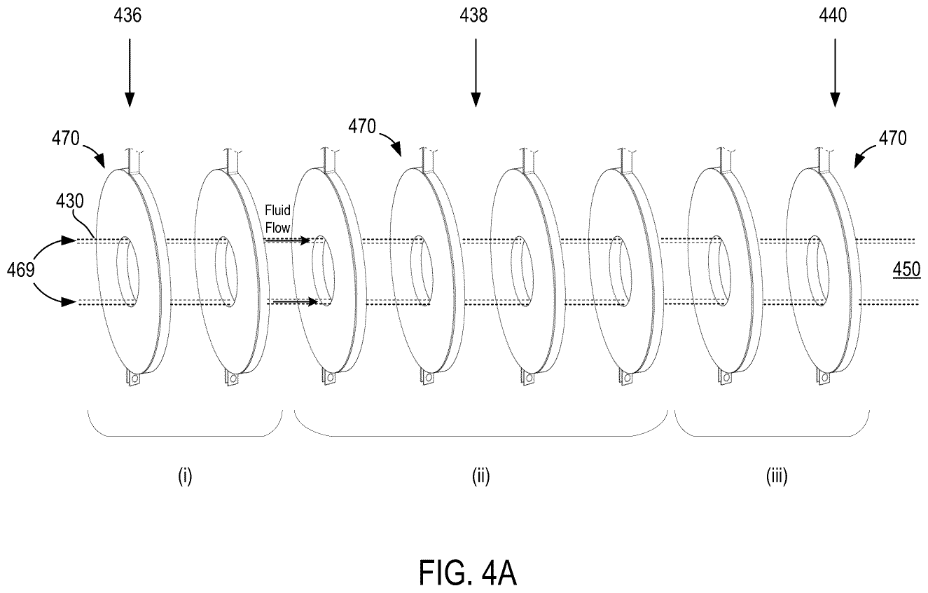

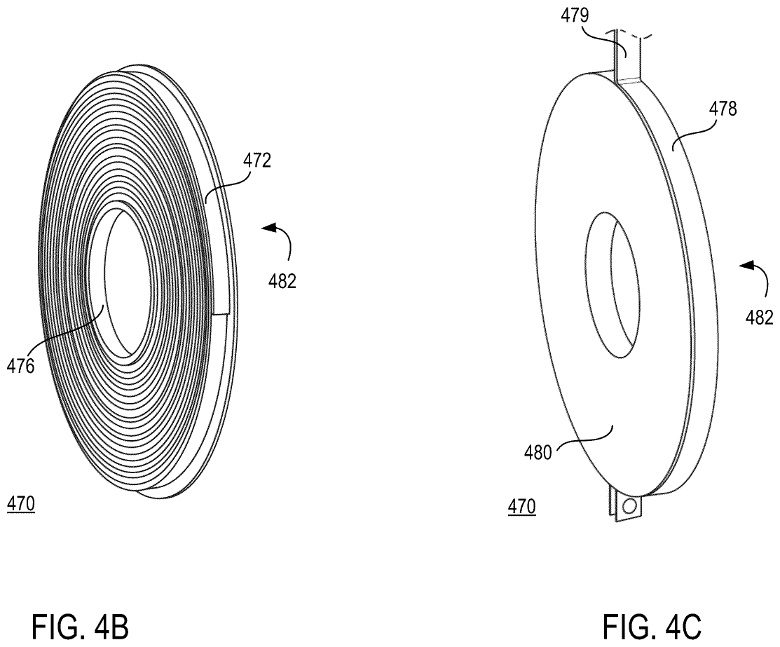

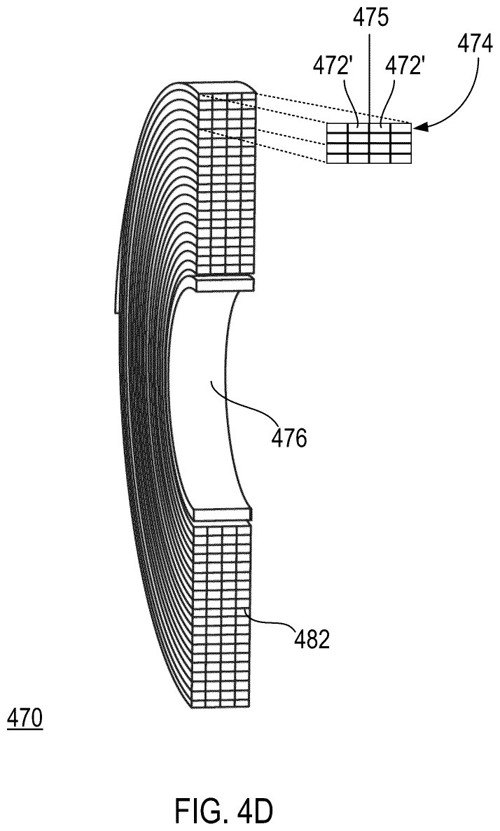

Turning now to FIGS. 4A-4C, an example of a coil assembly 17, in accordance with aspects of the present disclosure, is illustrated. As shown, in some embodiments, the coil assembly 17 may include a number of coil units 470, where a coil unit 470 may be arranged about a hollow duct 430 and core 450, as described with reference to FIGS. 2A-2B, and 3A-3F.

In some embodiments, a coil unit 470 in the coil assembly 17 may include a winding of a conductive strip 472 (FIG. 4B). The winding of the conductive strip 472 may have any number of turns, such as 80 turns, or less, or more. To prevent electrical shorting upon winding, the conductive strip 472 may include one or more layer of insulating material (e.g., alumina). In some embodiments, a coil unit 470 may include a conductive matrix 474 that includes a number of conductive strips 472′ arranged in the array. Conductive strips 472 in the conductive matrix 474 that are adjacent to one another may be separated laterally by an insulating barrier 475 to prevent electrical shorting, as illustrated in FIG. 4D. In addition, the conductive matrix 474 may also include one or more layer of insulating material coating the conductive matrix 474 to prevent electrical shorting upon winding of the conductive matrix 474.

The conductive strip 472 or conductive matrix 474 may be wound about a stator ring 476, as illustrated in FIG. 4B. In some embodiments, the stator ring 476 may have an inner diameter that corresponds to an outer diameter of the hollow duct 430, as shown in FIG. 4A. The stator ring 476 may be made using any material, such as calcium silicate material. In some applications, the stator ring 476 may help control overheating/stress damage to the coil unit 470.

In some embodiments, at least one conducting strap 478 may be attached or connected to an outer diameter of a coil unit 470, with the conducting strap(s) 478 making an electrical connection to the conductive strip 472, conductive matrix 474, or portion thereof, on the outer diameter of the coil unit 470, as shown in FIG. 4C. Further, in some embodiments, the coil unit 470 may also include a first disk 480 on a first side of the coil unit 470 and a second disk 482 and the second side of the coil unit 470. The first disk 480 may be attached or attachable to the first side of the coil unit 470. Similarly, the second disk 482 may be attached or attachable to the second side of the coil unit 470. In this manner, the first disk 480, the second disk 482, or both, may provide support and/or protection for the conductive strip 472 or the conductive matrix 474 wound therebetween.

The coil units 470 in the coil assembly 17 may be selectively operable and/or configured to generate and control magnetic field generated in or about an annular channel 469 produced by the hollow duct 430 and core 450, as shown in FIG. 4A. For instance, in embodiments, the coil assembly 17 may include a first set (i) of coil units 470, a second set (ii) of coil units 470, and a third set (iii) of coil units 470, as illustrated in FIG. 4A. As shown, the first set (i) of coil units 470 may be arranged near or about an inlet portion 436 of the hollow duct 430. The second set (ii) of coil units 470 may be arranged near or about a central portion 438 of the hollow duct 430, and the third set (iii) of coil units 470 may be arranged near or about the outlet portion 440 of the hollow duct 430.

Configuration and/or operation of the first set (i), second set (ii), and/or third set (iii) of coil units 470 may vary. For instance, a winding of conductive strips 472 in respective set of coil units 470 may vary. For example, in some embodiments, a winding of conductive strips 472 in the first set (i) of coil units 470 and in the third set (iii) of coil units 470 may be less (i.e., fewer turns) than the winding of conductive strips 472 in the second set (ii) of coil units 470. Further, in some embodiments, a winding of conductive strips 472 in the first set (i) of coil units 470 and in the third set (iii) of coil units 470 may decrease in a direction away from the central portion 438 of the hollow duct 430. Such variation in winding may be used to generate magnetic field gradients that may help control a profile of magnetic field (e.g., longitudinal magnetic field values, radial magnetic field values, and so forth) in the annular channel 469, and particularly magnetic field near the inlet portion 436 and the outlet portion 440 of the hollow duct 430.

Coil units 470 in the coil assembly 17 may be individually and/or collectively connected or connectable to one or more power source (e.g., a voltage source, a current source, and so forth) that may supply power for energizing the coil units 470 and generating a varying magnetic field in the annular channel 469. In some embodiments, the one or more power source may provide power in various phases to the coil units 470. In some implementations, coil units 470 in the first set (i) of coil units 470, the second set (ii) of coil units 470, and the third set (iii) of coil units 470 may be connected or connectable and operated in a three-phase configuration. For instance, the coil units 470 may be connected and operated using an AA ZZ BB XX CC YY sequence, where A, B, C represent a balanced three-phase configuration, and X, Y, Z, represent an opposite phase. For example, for phases A:0°, B:120° and C:240°, phases may be X:180°, Y:300° and Z:60°.

Responsive to the varying magnetic field generated by coil units 470 in the coil assembly 17, a pressure variation may be generated in a conducting fluid present in or flowing through the annular channel 469. Specifically, a body force may be produced on the conducting fluid via interaction between electric current and magnetic field in the conducting fluid. The body force may produce a pressure rise in the conducting fluid. The pressure rise may then drive a movement of the conducting fluid through the annular channel 469, thereby generating a pumping of the conducting fluid.

While FIG. 4A illustrates one example of a coil assembly 17, various modifications may be possible. For instance, the coil assembly 17 may include more or fewer coil units 470. More particularly, fewer or more coil units 470 may be included in the first set (i) of coil units 470, the second set (ii) of coil units 470, and the third set (iii) of coil units 470, or in a combination thereof.

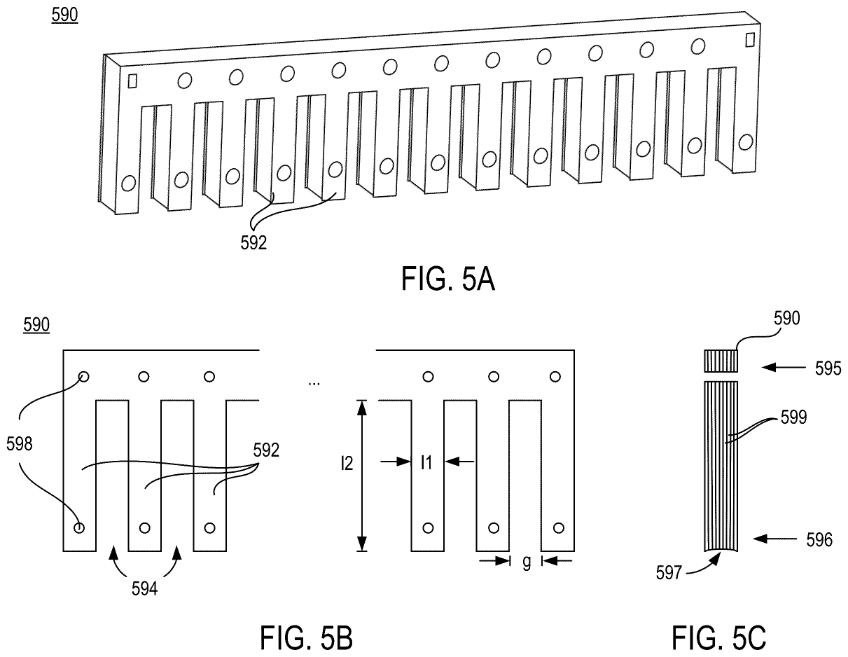

As described, the electromagnetic pump 10 includes a stator assembly 19 with a number of stator units 190. As illustrated in FIGS. 5A and 5B, in some embodiments, a stator unit 590 may include a number of dividers 592 of with lateral dimension l1 and longitudinal dimension l2. The dividers 592 may be separated by gaps 594 with lateral dimension g. Each gap 594 of the stator unit 590 may be configured to receive a section of a coil unit in a coil assembly, for instance, as described with reference to FIGS. 4A-4D. In particular, a coil unit 470 may be positioned in a gap 594 between the dividers 592, for instance, in a tight or interference fit (e.g., leaving a space of approximately 0.01″, or less). As illustrated in FIG. 5C, a divider 592 of the stator unit 590 extends from an upper portion 595 to a lower portion 596, where the lower portion 596 may include a curved portion 597, allowing the stator unit 590 to be positioned on an outer diameter of a hollow duct, for instance, as described with reference to FIGS. 2A-2B. In some embodiments, a curvature of the curved portion 597 substantially matches the curvature of the hollow duct on the outer diameter. In some embodiments, a stator assembly may include 4 stator units 590, positioned every 90 degrees on a circumference of a hollow duct, as described. In yet other embodiments, a stator assembly may include 6 stator units 590, positioned every 60 degrees on a circumference of a hollow duct.

In some embodiments, the stator unit 590 may be attached or attachable to a support structure, for instance, as described with reference to FIGS. 1A and 1B. To this end, the stator unit 590 may include a number of openings 598 for receiving a number of fasteners, as shown in FIGS. 5A and 5B.

In some embodiments, the stator unit 590 may be configured to direct a time-varying magnetic field, generated by one or more coil units 470, in a direction perpendicular to the direction of flow of the conducting fluid, as shown in FIG. 3D, for example. To this end, a structure and/or material of the stator unit 590 may be configured to control a direction of a time-varying magnetic field. For example, in some embodiments, the stator unit 590 may include a number of stator sheets 599, as illustrated in FIG. 5C. In some embodiments, stator sheets 599 in a stator unit 590 may be separated by an insulating material or may be laminated to form laminated sheets. The stator sheets 599 may extend radially as shown in FIG. 5C. In some embodiments, the stator sheets 599 may include a magnetic material. By way of example, the stator unit 590 may include a Ni—Cr—Co—Mo alloy material or a Fe—Si Steel material. The stator sheets 599 and/or magnetic material therein may then direct magnetic field generated by one or more coil units in the coil assembly may be directed radially (i.e., along a length or long axis of the stator sheets 599 shown in FIG. 5C) and help close a magnetic circuit for the magnetic field via a core, as described.

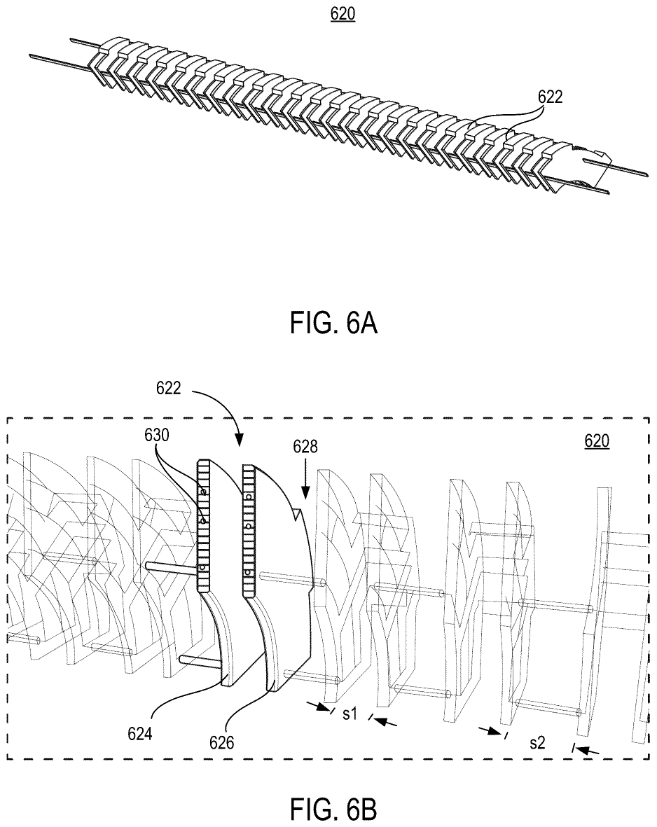

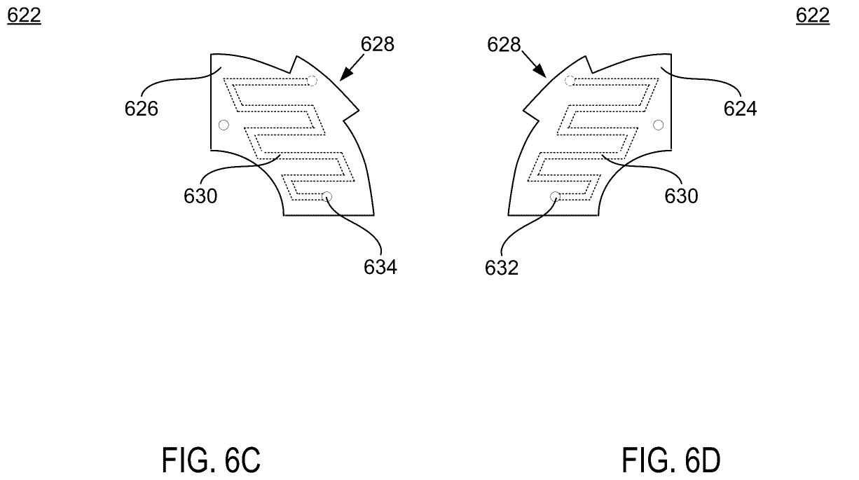

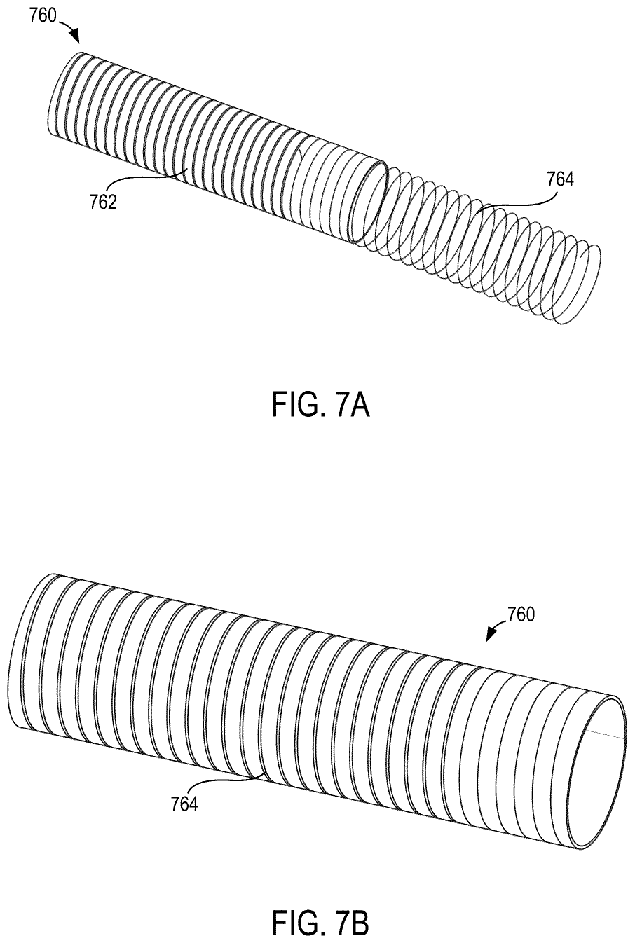

As described, an electromagnetic pump may be operated at high temperatures. Hence, in some embodiments, a cooling system may be desirable to control temperature in the electromagnetic pump. Turning to FIGS. 6A to 6D, an example of a cooling stack 620 of a cooling system, in accordance with aspects of the present disclosure, is illustrated. The cooling stack 620 may include a number of cooling units 622 arranged in sequence (e.g., along a longitudinal direction of the electromagnetic pump) and fluidly connected to one another, as shown in FIG. 6B. In some embodiments, a cooling unit 622 may include a first cooling plate 624, a second cooling plate 626 spaced by a first separation s1 from the first cooling plate 624, and a connector plate 628 connecting the first cooling plate 624 and the second cooling plate 626. Cooling units 622 in the cooling stack 620 may be spaced by a second separation s2, as shown in FIG. 6B.

As illustrated in FIGS. 6B-6D, the first cooling plate 624, the second cooling plate 626, and connector plate 628 may include a network of microchannels 630 formed therein, where the microchannels 630 may carry a cooling fluid entering the cooling unit 622 through at least one cooling unit input 632 and exiting the cooling unit 622 through at least one cooling unit output 634. The arrangement of the network of microchannels 630 may vary.

In some embodiments, the first separation s1 between the first cooling plate 624 and the second cooling plate 626 may be configured to correspond to a width of a coil unit 470, as described with reference to FIGS. 4A-4D. In this manner, the coil unit 470 may be positioned between the first cooling plate 624 and the second cooling plate 626 to provide cooling to the coil unit 470.

In some embodiments, a cooling system, in accordance with aspects of the present disclosure, may include a cooling sleeve 760, as illustrated in FIGS. 7A and 7B. The cooling sleeve 760 may include a helical channel 762 extending along a length of the cooling sleeve 760. As shown, the helical channel 762 may receive a helical cooling coil 764 that may carry a cooling fluid to cool the cooling sleeve 760, and components arranged therein. The cooling sleeve 760 may be configured, for example, by way of an inner diameter, to fit around one or more components, such as stator units 590 as described with reference to FIGS. 5A-5C, and coil units 470, as described with reference to FIGS. 4A-4D.

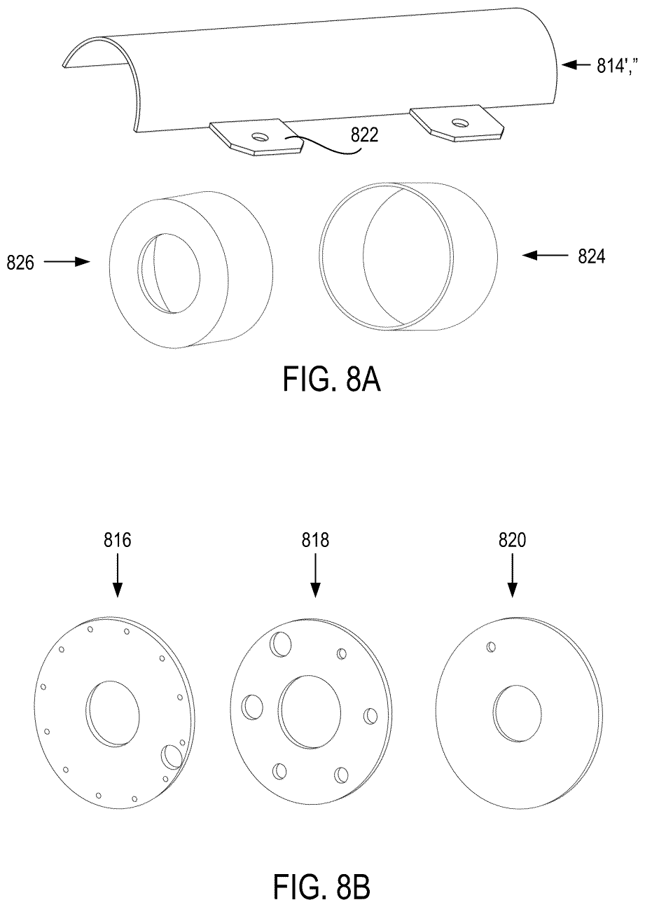

As described, an electromagnetic pump, in accordance with aspects of the present disclosure, may include a support structure. In some embodiments, illustrated in FIGS. 8A and 8B, the support structure may include a first shell 814′ and a second shell 814″, a first end plate 816, a second end plate 818, a third plate 820. The support structure may also include at least one end collar 822 and at least one cover 824. Together, components of the support structure can provide structural rigidity, access, and/or protection of components of the electromagnetic pump.

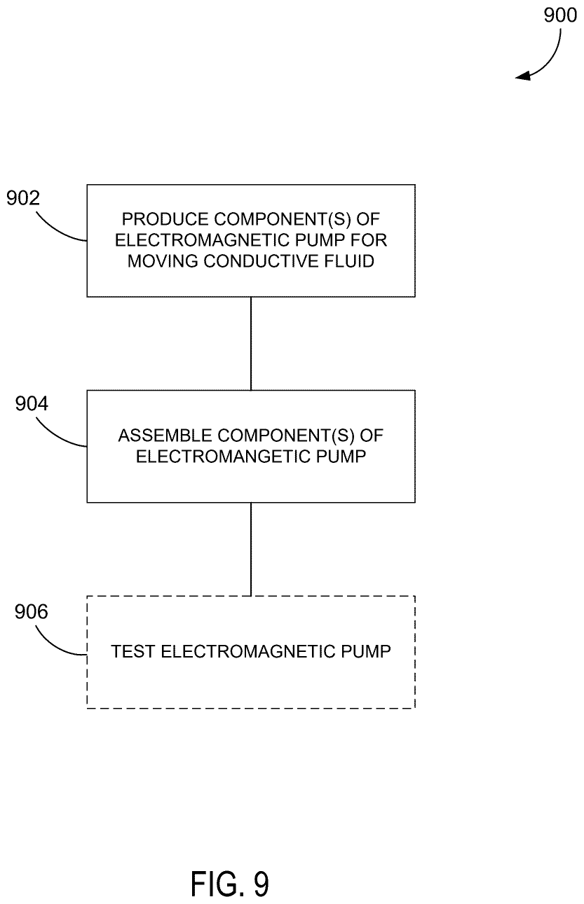

Turning now to FIG. 9 a flowchart setting forth steps of a process 900 for manufacturing an electromagnetic pump for moving conductive fluid, according to aspects of the present disclosure, is illustrated. Steps of the process 900 may be carried out using any suitable devices, tools, hardware, systems, and so forth. Although the process 900 is illustrated and described as a sequence of steps, it is contemplated that the steps may be produced in any order or combination, need not include all illustrated steps, and may include additional steps.

The process 900 may begin at process block 902 with producing various components of the electromagnetic pump, in accordance with aspects of the present disclosure. Components of the electromagnetic pump may be produced using various manufacturing and/or forming techniques, such as casting, molding, machining, 3D printing, and other techniques.

In some implementations, process block 402 may include producing a hollow duct extending from a first duct end to a second duct end, the hollow duct having an inlet portion, a central portion, and an outlet portion. As described, a hollow duct can carry a conductive fluid (e.g., a molten salt, liquid metal, and so forth). To this end, the hollow duct may be produced using material that may withstand high temperature, thermal gradients, corrosion, and so forth. For instance, the hollow duct 230 may be produced using a high-temperature alloy material, such as a Ni-Cr alloy material (e.g., Hastelloy, Iconel 617, and so forth). In some embodiments, the hollow duct may be coated on the interior and/or exterior with a protective layer, such as a Ni layer, an alumina layer, and so forth, with a thickness of 50 micrometers, or more.

In some implementations, process block 402 may include producing a core that includes a first core end, a core body, a second core end. In some implementations, the core may be produced using an additive manufacturing technique (e.g., a 3D printing technique). By way of example, the first core end, the core body, and second core end may be produced using a magnetically permeable material (e.g., Inconel 617, and so forth). As described, in some embodiments, the core body may include a magnetic rod or magnetic tube within its volume. In some implementations, the magnetic rod or magnetic tube may be produced using an additive manufacturing technique.

In some implementations, process block 402 may include producing a coil assembly. As described, the coil assembly may include a number of coil units. As described, a coil unit may include a winding of a conductive strip or conductive matrix. In some implementations, a conductive strip or conductive matrix in the coil assembly may be produced using an aluminum carbide alloy (e.g., Al—Al₄C₃ alloy). In some implementations, a conductive strip(s) and/or conductive matrix/matrices may be produced using an additive manufacturing technique. To prevent electrical shorting upon winding, a conductive strip or conductive matrix in the coil assembly may be coated with an insulating layer (e.g., an alumina layer), using various coating techniques. A length of produced conductive strips and/or conductive matrices may vary, depending upon desired winding (e.g., approximately 80 turns, or more, or less). As described, a winding of different coil units in the coil assembly may vary.

Produced conductive strips or conductive matrices in the coil assembly may then be wound using various techniques. In some implementations, a produced conductive strip or conductive matrix may be wound about a stator ring. As described, a stator ring may be formed using any insulating material, such as calcium silicate material (e.g., a CaSiO₃ material). In some implementations, the stator ring(s) may be formed using an additive manufacturing technique.

In some implementations, process block 402 may include producing a stator assembly with a number of stator units. As described, a stator unit may include a number of dividers separated by gaps. The stator unit(s) may be formed using various materials. In some implementations, the stator unit(s) may be formed using a material that may keep magnetic properties (e.g., high magnetic saturation) at high temperature (e.g., temperature greater than 1000K or greater than 1200K). For example, the stator unit(s) may be formed using an Fe—Co—V alloy material (e.g., Hiperco 50, Hiperco 50A, Hiperco 50 HS, and so forth). In some implementations, a stator unit in the stator assembly may be formed using a number of stator sheets, as described.

In some implementations, process block 402 may include producing a cooling system. As described, the cooling system may include a number of cooling stacks, where a cooling stack includes a number of cooling units fluidly connected to one another to form a closed-loop cooling circuit. As described, a cooling unit may include a first cooling plate, a second cooling plate spaced from the first cooling plate, and a third cooling plate connecting the first cooling plate and the second cooling plate. A cooling plate may be formed to include a network of microchannels running therethrough. In some implementations, a cooling stack may be formed using a material that can achieve electrical insulation and high thermal conductivity. For example, a cooling stack may be formed using Ceralloy 147-31N. In some implementations, a cooling stack may be formed using an additive manufacturing technique.

In some implementations, a cooling sleeve may be produced at process block 402. As described, the cooling sleeve may include a helical channel extending along a length of the cooling sleeve. The helical channel may be formed to receive a helical cooling coil that may carry a cooling fluid to cool the cooling sleeve, and components arranged therein. The cooling sleeve and helical cooling coil may be formed using any material. For example, the helical sleeve may be formed using a calcium silicate material (e.g., Ceralloy 147, and so forth). The helical cooling coil may be formed using a Ni—Cr alloy material (e.g., Hastelloy, Iconel 617, and so forth).

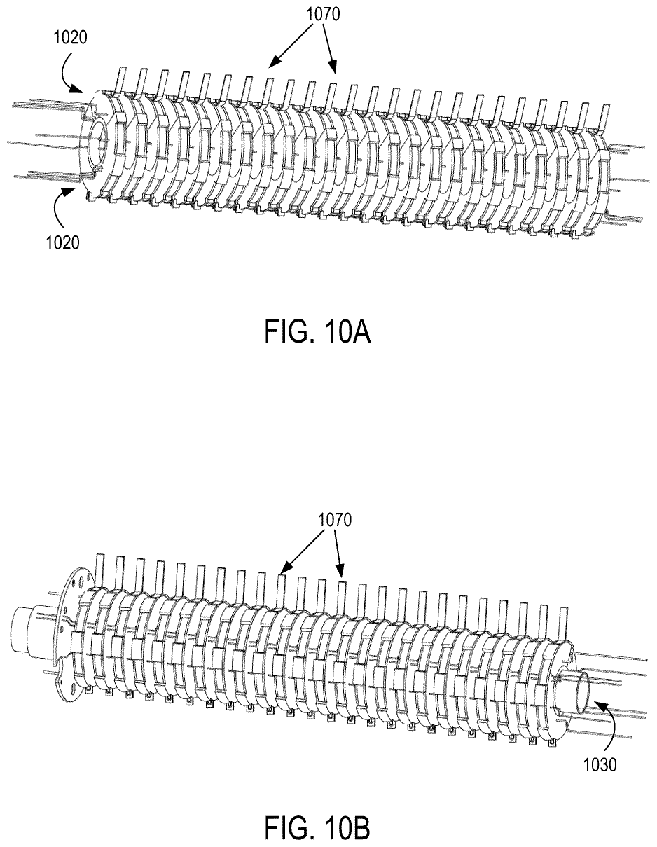

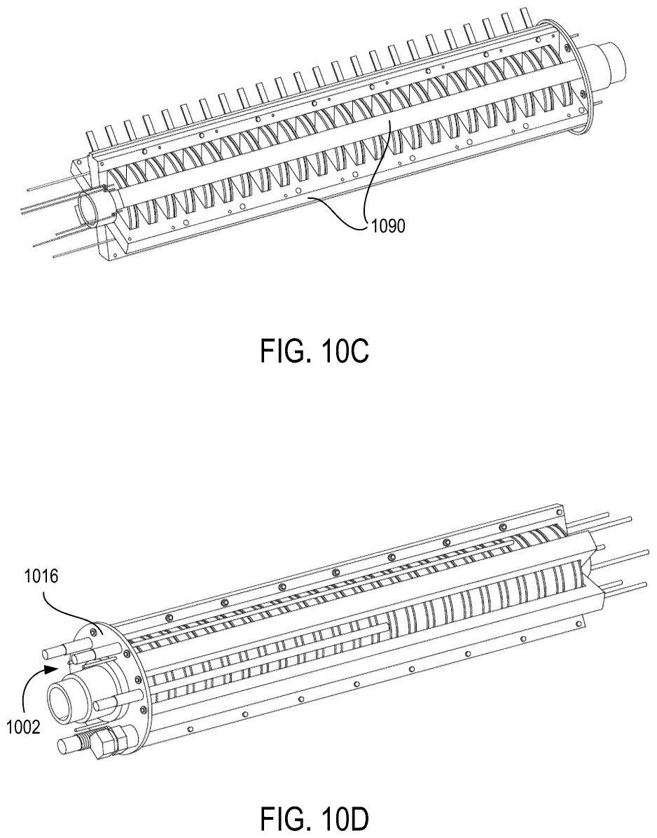

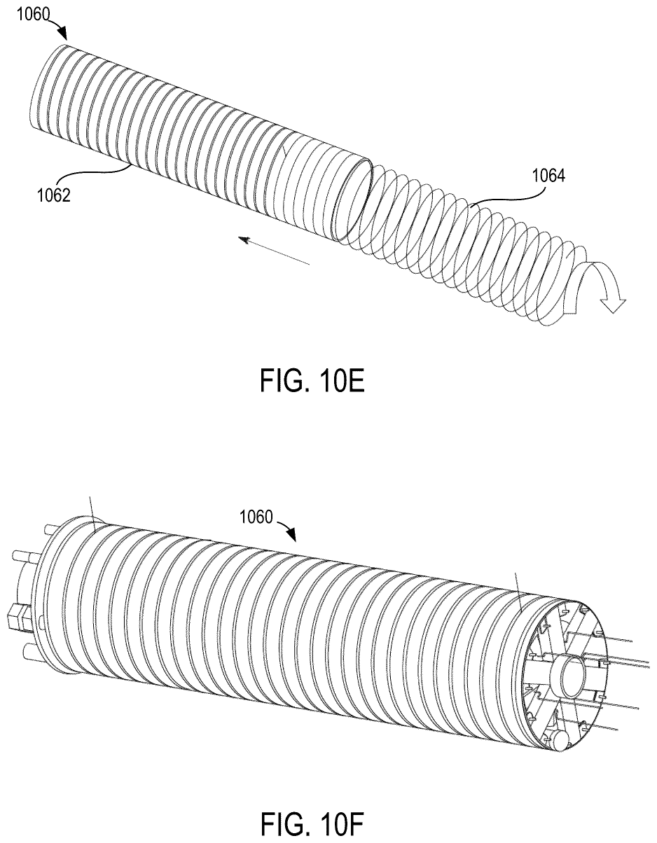

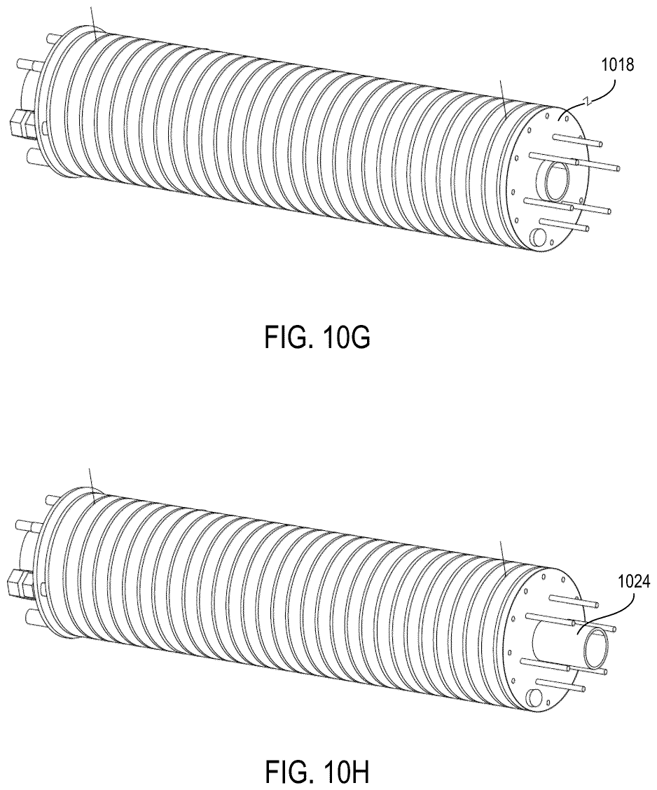

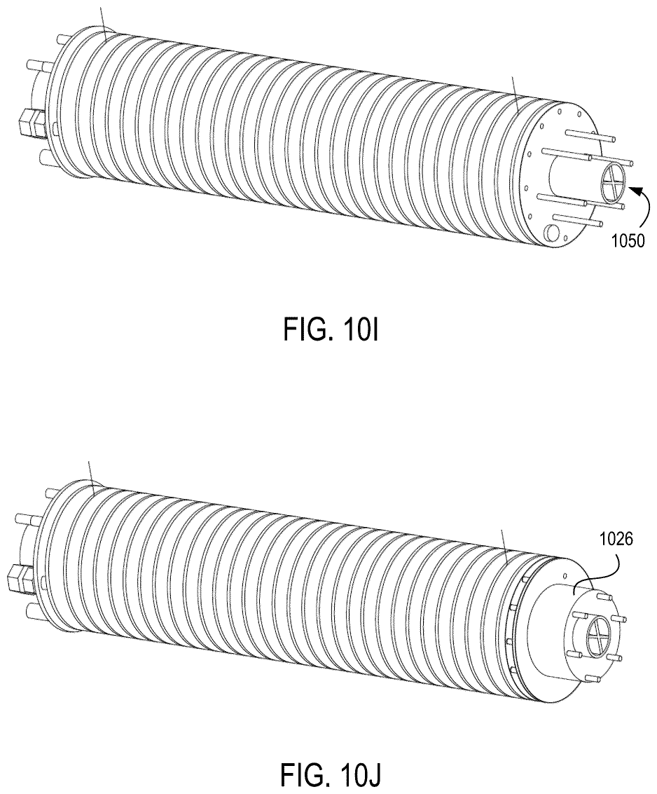

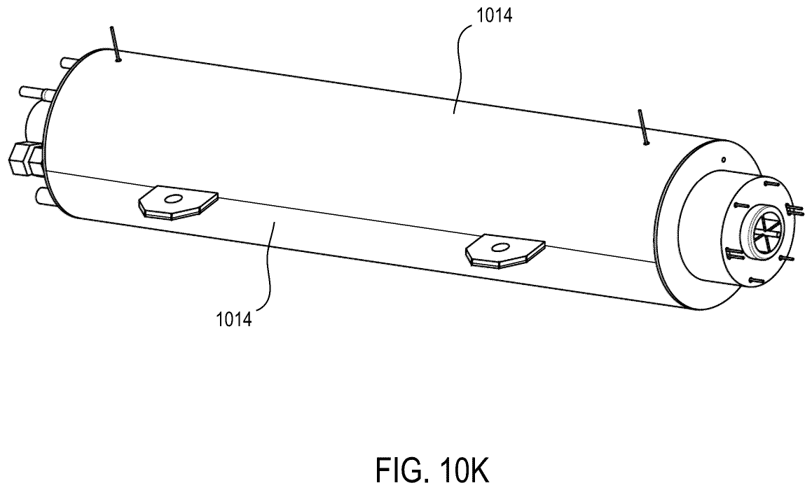

Components of the electromagnetic pump produced at process block 902 may be assembled, as indicated by process block 904. By way of example, FIGS. 10A-10K illustrates one possible approach of assembling components of the electromagnetic pump produced at process block 902.

Referring specifically to FIG. 10A, produced cooling stacks 1020 may be attached or connected to a coil assembly having a plurality of coil units 1070, whereby cooling units are inserted between coil units 1070, for instance, in a tight or interference fit. The cooling stacks 1020 and coil assembly may then be positioned about a hollow duct 1030, whereby tubing from the cooling stacks 1020 is inserted through openings in a first end plate, as illustrated in FIG. 10B. Stator units 1090 in a stator assembly may then be attached or affixed to one or more components of the electromagnetic pump (e.g., coil unit, end plate, and so forth), for instance, using one or more fastener, tight or interference fitting, and so forth (FIG. 10C). Dividers of stator units 1090 in the stator assembly may or may not contact the hollow duct 1030. In some implementations, thermocouple bars 1002 may be installed using openings in the first end plate 1016 (FIG. 10D). A helical coil 1064 may then be installed in the helical channel 1062 of a cooling sleeve 1060 (FIG. 10E), and the cooling sleeve 1060 may then be positioned about over the stator assembly, coil assembly, and cooling stacks, as shown in FIG. 10F. A second end plate 1018 may then be positioned on the electromagnetic pump, whereby tubing of the cooling stacks is inserted through openings in the second end plate 1016 (FIG. 10G). The stator assembly may be fastened to the second end plate 1018 using various fasteners. An end collar 1024 may then be installed on the second duct end, and secured in place (e.g., via welding), as illustrated in FIG. 10H. A core 1050 may be inserted into the hollow duct 1030 (FIG. 10I), and an end cover 1026 may then be attached to the second end plate 1018, as illustrated in FIG. 10J. Shell components 1014 may then be installed over the electromagnetic pump, and secured in place (e.g., using fasteners, welding, and so forth), as illustrated in FIG. 10K. In some implementations, an internal space of the electromagnetic pump, such as the space between the shell component(s) 1014, end plate(s), hollow duct 1030, stator units 1090, and coil units 1070, may be filled with a filler. In some embodiments, the internal space may be filled with a material that is electrically insulating. Alternatively, or additionally, the internal space may be filled with a material that is thermally conductive. For example, the filler may include a Ceralloy powder.

Referring again to FIG. 9, in some implementations, the electromagnetic pump may be tested, as indicated by process block 906. To this end, the electromagnetic pump manufactured, as described, may be connected to one or more sources of conductive fluid, as well as one or more sources of power for energizing the coil assembly. The report may be in any form and provide any information. For example, in some implementations, a report may indicate pump performance, pumping speed, temperature, pressure, and so forth.

One or more elements or aspects or steps, or any portion(s) thereof, from one or more of any of claims herein can be combined with one or more elements or aspects or steps, or any portion(s) thereof, from one or more of any of the other claims or combinations thereof, to form one or more additional implementations and/or claims of the present disclosure.

While various examples of the present disclosure have been described above, it should be understood that they have been presented by way of example only, and not limitation. Numerous changes to the disclosed examples can be made in accordance with the disclosure herein without departing from the spirit or scope of the disclosure. Thus, the breadth and scope of the present disclosure should not be limited by any of the above-described examples. Rather, the scope of the disclosure should be defined in accordance with the following claims and their equivalents.

Although the disclosure has been illustrated and described with respect to one or more implementations, equivalent alterations and modifications will occur to others skilled in the art upon the reading and understanding of this specification and the annexed drawings. In addition, while a particular feature of the disclosure may have been disclosed with respect to only one of several implementations, such feature may be combined with one or more other features of the other implementations as may be desired and advantageous for any given or particular application.

The terminology used herein is for the purpose of describing particular examples only and is not intended to be limiting of the disclosure. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, terms (including technical and scientific terms) used herein have the same meaning as commonly understood by one of ordinary skill in the art to which this disclosure belongs. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

What is claimed is:

1. A method for manufacturing an electromagnetic pump, the method comprising:
producing a hollow duct that extends from a first duct end to a second duct end, the hollow duct having an inlet portion, a central portion, and an outlet portion;
producing a core that extends from a first core end to a second core end;
producing a coil assembly comprising a first set of coil units, a second set of coil units, and a third set of coil units, wherein the first set of coil units, the second set of coil units, and the third set of coil units are operable to generate a time-varying magnetic field;
producing a stator assembly comprising a plurality of stator units; and
assembling the electromagnetic pump by:
arranging the first set of coil units about an inlet portion of the hollow duct, the second set of coil units about a central portion of the hollow duct, and the third set of coil units about an outlet portion of the hollow duct;
arranging the plurality of stator units about the hollow duct to receive a portion of the first set of coil units, the second set of coil units, and the third set of coil units; and
arranging the core inside the hollow duct to form an annular channel between the hollow duct and core for carrying a conductive fluid in response to the time-varying magnetic field.

2. The method of claim 1, wherein the method further comprises forming the hollow duct using a Ni—Cr—Co—Mo alloy material.

3. The method of claim 1, wherein the method further comprises lining an inner surface of the hollow duct with a Ni layer.

4. The method of claim 1, wherein the method further comprises producing the core with a diameter that tapers toward the first core end and toward the second core end to form an inlet nozzle at the first core end and an outlet nozzle at the second core end.

5. The method of claim 1, wherein the method further comprises producing the core with a first set of fins at the first core end and a second set of fins at the second core end, wherein a set of fins extends radially outward to align the core inside the hollow duct.

6. The method of claim 1, wherein the method further comprises introducing a magnetic rod or a magnetic tube inside the core.

7. The method of claim 6, wherein the method further comprises forming the magnetic rod or the magnetic tube with a Fe—Co—V alloy material.

8. The method of claim 1, wherein the method further comprises producing a coil unit in the first set of coil units, the second set of coil units, and the third set of coil units by winding a conductive strip or a conductive matrix, wherein the conductive strip or the conductive matrix comprises an insulating layer.

9. The method of claim 8, wherein the method further comprises winding the conductive strip or the conductive matrix of the coil unit around a stator ring.

10. The method of claim 9, wherein the method further comprises producing the stator ring using a calcium silicate material.

11. The method of claim 8, wherein the method further comprises attaching to the coil unit a conducting strap.

12. The method of claim 8, wherein the method further comprises positioning a first disk on a first side of the coil unit and a second disk on a second side of the coil unit.

13. The method of claim 1, wherein the method further comprises producing coil units in the first set of coil units, the second set of coil units, and the third set of coil units so that a winding of conductive strips or conductive matrices in in the first set of coil units and in the third set of coil units is less than the winding of conductive strips in the second set of coil units.

14. The method of claim 13, wherein the method further comprises producing coil units in the first set of coil units, the second set of coil units, and the third set of coil units so that the winding of conductive strips in the second set of coil units and in the third set of conducting units decreases in a direction away from the central portion of the hollow duct.

15. The method of claim 1, wherein the method further comprises producing a stator unit of the plurality of stator units using a plurality of stator sheets.

16. The method of claim 15, wherein the method further comprises producing the stator unit of the plurality of stator units using laminated sheets.

17. The method of claim 15, wherein the method further comprises producing the stator unit of the plurality of stator units using a Ni—Cr—Co—Mo alloy material or a Fe—Si Steel material.

18. The method of claim 1, wherein the method further comprises producing a cooling system with a plurality of cooling stacks, a cooling stack comprising a plurality of cooling units fluidly connected, wherein a cooling unit comprises a network of microchannels for carrying a cooling fluid.

19. The method of claim 18, wherein the method further comprises arranging cooling stacks of the plurality of cooling stacks about the first set of coil units, the second set of coil units, and the third set of coil units, wherein a cooling unit is positioned between successive coil units.

20. The method of claim 1, wherein the method further comprises producing a cooling sleeve comprising a helical channel, wherein the helical channel is configured to receive a cooling coil for carrying a cooling fluid.

21. The method of claim 1, wherein the method further comprises producing a support structure comprising at least one shell.

22. The method of claim 19, wherein the method further comprises introducing an a filler into an internal space of the electromagnetic pump.

23. The method of claim 1, wherein the method further comprises producing the hollow duct, the core, the coil assembly, the stator assembly, or a combination thereof, using an additive manufacturing process.
